(19) United States
(12) Patent Application Publication
(10) Pub. No.: US 2018/0027002 A1
(43) Pub. Date: Jan. 25, 2018

(54) OUTLIER DETECTION IN ENTERPRISE THREAT DETECTION

(71) Applicant: SAP SE, Walldorf (DE)

(72) Inventors: Marco Rodeck, Maikammer (DE); Florian Chrosziel, St. Leon-Rot (DE); Jona Hassforther, Heidelberg (DE); Rita Merkel, Ilvesheim (DE); Thorsten Menke, Bad Iburg (DE); Thomas Kunz, Lobbach/Lobenfeld (DE); Hartwig Seifert, Elchesheim-Illingen (DE); Harish Mehta, Wiesenbach (DE); Wei-Guo Peng, Dallau (DE); Lin Luo, Wiesloch (DE); Eugen Pritzkau, Wiesloch (DE)

(21) Appl. No.: 15/216,046

(22) Filed: Jul. 21, 2016

(51) Int. Cl. H04L 29/06; G06F 17/30; G06F 3/0482; H04L 29/08; H04L 12/26

(52) U.S. Cl. CPC H04L 63/1425; H04L 67/02; H04L 67/146; H04L 43/045; H04L 43/10; H04L 67/24; H04L 63/1433; H04L 63/1416; G06F 3/0482; G06F 17/30601

(57) ABSTRACT

A selection of data types is defined from available log data for an evaluation of events associated with an entity. One or more evaluations are defined that are associated with the entity. Reference data is generated from the selection of data types based on the one or more defined evaluations. The one or more evaluations are grouped into a pattern. A visualization is initiated for display in a graphical user interface of a normalized score for the entity for each evaluation associated with the pattern against a determined anomaly threshold.

### BACKGROUND

Enterprise threat detection (ETD) typically collects and stores a large amount of log data from various systems associated with an enterprise computing system. The collected log data is usually analyzed using forensic-type data analysis tools to identify suspicious behavior and to allow an appropriate response. The stored log data is normally purged on a periodic basis to conserve storage and computing resources. As a result, threats which can be found only in correlation with several events and in comparison with known past behavior are difficult to determine and to visualize once the collected log data is unavailable for further processing.

### SUMMARY

The present disclosure describes methods and systems, including computer-implemented methods, computer program products, and computer systems for enhanced enterprise threat detection (ETD) using statistical methods.

In an implementation, a selection of data types is defined from available log data for an evaluation of events associated with an entity. One or more evaluations are defined that are associated with the entity. Reference data is generated from the selection of data types based on the one or more defined evaluations. The one or more evaluations are grouped into a pattern. A visualization is initiated for display in a graphical user interface of a normalized score for the entity for each evaluation associated with the pattern against a determined anomaly threshold.

The above-described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method/the instructions stored on the non-transitory, computer-readable medium.

The subject matter described in this specification can be implemented in particular implementations so as to realize one or more of the following advantages. First, the described methodology and user interface (UI) permit large of amounts of raw log data from various systems associated with an enterprise computing system to be analyzed in order to find suspicious behavior. Additionally, threats can be discovered due to correlation between several events and known prior behavior. Second, the methodology and UI provide rich statistical and visualizations. Third, a two-step approach is used to build up reference data for specified features (for example, entity-based characteristics and on time-based information such as day-of-week, hour-of-day, etc.). Relevant reference data for each feature is copied to a dedicated database as intermediate reference data. Selected aggregation levels are used to perform aggregation on the intermediate reference data to generate reference data. During creation of the reference data, expected value and standard deviation are calculated for each feature associated with the reference data. Fourth, the reference data can be used to calculate/re-calculate the relevant reference data. This is due to long-term storage of the reference data when compared to the typical time frame the raw log data is stored prior to being purged to conserve storage and computing resources. Fifth, feature spaces can be generated from characteristics and time-based information associated with a particular entity. Each feature associated with a feature space has a feature score calculated. Sixth, the UI permits a security expert to quickly note outlier values for each particular feature score and to determine whether the detected outlier value is critical (for example, the outlier value exceeds a determined threshold value, the particular feature is itself deemed critical, etc.) and requires further investigation. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a screenshot of an example enterprise threat detection (ETD) anomaly detection lab upper level user interface, according to an implementation.

FIG. 2 is a screenshot of an example ETD anomaly detection lab open pattern user interface, according to an implementation.

FIG. 3 is a screenshot of an example ETD anomaly detection lab pattern selection user interface, according to an implementation.

FIG. 4 is a screenshot of an example ETD anomaly detection lab pattern definition user interface, according to an implementation.

FIG. 5 is a screenshot of an example ETD anomaly detection lab analysis user interface, according to an implementation.

FIG. 6 is a screenshot of example ETD anomaly detection lab evaluation detail functionality, according to an implementation.

FIG. 7 is a screenshot of example ETD anomaly detection lab score tooltip functionality, according to an implementation.

FIG. 8 is a screenshot of an example ETD anomaly detection lab pattern selection & time range selection functionality, according to an implementation

FIG. 9 is a flowchart of an example method for enhanced enterprise threat detection (ETD) using statistical methods, according to an implementation.

FIG. 10 is a block diagram of an exemplary computer system used to provide computational functionalities associated with described algorithms, methods, functions, processes, flows, and procedures as described in the instant disclosure, according to an implementation.

Like reference numbers and designations in the various drawings indicate like elements.

### DETAILED DESCRIPTION

The following detailed description describes enhanced enterprise threat detection (ETD) using statistical methods and is presented to enable any person skilled in the art to make and use the disclosed subject matter in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described or illustrated implementations, but is to be accorded the widest scope consistent with the principles and features disclosed herein.

For the purposes of this disclosure, the term “real-time,” “real time,” “realtime,” “real (fast) time (RFT),” “near(ly) real-time (NRT),” “quasi real-time,” or similar terms (as understood by one of ordinary skill in the art), if used, means that an action and a response are temporally proximate such that an individual perceives the action and the response occurring substantially simultaneously. For example, the time difference for a response to display (or for an initiation of a display) of data following the individual's action to access the data may be less than 1 ms, less than 1 sec., less than 5 secs., etc. While the requested data need not be displayed (or initiated for display) instantaneously, it is displayed (or initiated for display) without any intentional delay, taking into account processing limitations of a described computing system and time required to, for example, gather, accurately measure, analyze, process, store, and/or transmit the data.

ETD typically collects and stores a large amount of log data in an ETD system data storage (for example, an in-memory database or other type of data storage) from various systems associated with an enterprise computing system. The collected log data is usually analyzed using forensic-type data analysis tools to identify suspicious behavior and to allow an appropriate response. Stored log data is normally purged on a periodic basis to conserve storage and computing resources. As a result, threats which can be found only in correlation with several events and in comparison with known past behavior are difficult to determine and to visualize once the collected log data is unavailable for further processing. This disclosure describes enhancing ETD by statistical methods in order to build up reference data for specified evaluations in a two-step approach.

In a first step, for an entity (for example, a user—human being, technical user, etc., system—backend server system, etc.), relevant reference data for specified evaluations associated with the entity (for example, characteristics and on time-based information such as day-of-week, hour-of-day, etc.) received in raw log file data is copied to a database (for example, in one or more dedicated database tables) to generate intermediate reference data. In typical implementations, the database can be an in-memory database. In alternative implementations, the database can be a conventional database, a combination of in-memory and conventional databases, or other type of database consistent with the requirements of this disclosure as would be understood by those of ordinary skill in the art. The intermediate reference data is typically a subset of the received raw log file data. Database tables for intermediate reference data (and reference data—see below) are designed to store data for specified evaluations for outlier value detection. For example, if a specified evaluation is “number of logons,” a number of logons grouped by user can be stored together with current date/time information as intermediate reference data for the “number of logons” evaluation. The amount of data kept in the ETD system representing the intermediate reference data is typically much less (condensed) when compared to the entirety of the originally received log data. As such, given particular data storage thresholds and computing resources, the generated reference data can be retained for a much longer periods of time when compared to storage of the raw log file data.

In a second step, the stored intermediate reference data is used to generate aggregation-level-based reference data (hereinafter “reference data”) based on a particularly defined aggregation level for a particular evaluation determined by entity-based characteristics and on time-based information (for example, day-of-week and hour-of-day). In some implementations, data that “maps” a level of aggregation and particular entity-based characteristics/time-based information associated with a particular evaluation can be stored (for example, in the database) for reference by the described methodology. Other methods of determining particular aggregation levels are also considered to be within the scope of this disclosure. As an example, for the above-described “number of logons” example, from the generated intermediate reference data, reference data can be generated where the “mapping” data specifies that the generated reference data is stored not on a current date/time information level (as with the intermediate reference data) but is instead aggregated on, for example, a day-of-week, hour-of-day, etc. basis and according to relevant attributes associated with the “number of logons” evaluation (for example, user, terminal, system identification, etc.). Aggregation can be performed on one or more values depending on particular needs, desires, or particular implementations of the described subject matter. During generation of the reference data, an expected value and standard deviation for each evaluation is calculated.

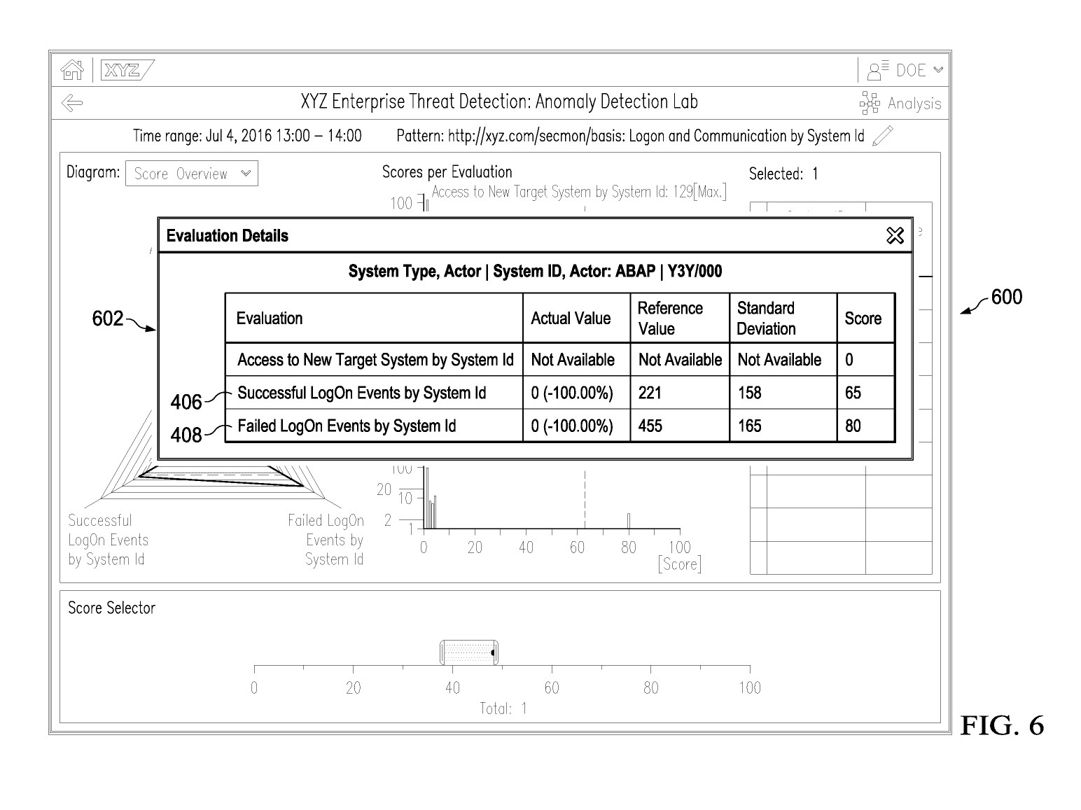

Each particular entity is associated with a “evaluation space” storing evaluations associated with the particular entity (for example, number of report calls, number of outbound calls, number of inbound calls, number of logon attempts, number of failed logon attempts, number of all successful logon attempts, and number of transaction calls, as illustrated in at least FIG. 6). A standard deviation evaluation score is calculated and normalized for each evaluation in the evaluation space associated with the particular entity. For example, for a particular evaluation, data from a certain time frame (for example, Wednesday, July 4^{th}, 13:00-14:00) is checked against the standard deviation value for the evaluation for this hour. If at any point an actual evaluation score exceeds (outlies) the calculated standard deviation evaluation score, the actual evaluation score is indicated as an outlier value on a user interface to permit a security expert to quickly visualize a deviation of the evaluation values for the particular evaluation to allow the security expert to judge whether the detected outlier is critical and needs further investigation (for example, the outlier value exceeds a determined threshold value, the particular evaluation is itself deemed critical, etc.).

The ETD system is able to calculate/re-calculate the reference data at any time based on the stored intermediate reference data. For example, for an example evaluation “Transaction Call” in an evaluation space named “User,” all transaction calls for a certain day are read and stored (for example, as described above) as intermediate reference data. The data is then aggregated (for example, as described above) by day-of-week, hour-of-day, user, and transaction code and then stored as reference data. Afterwards all intermediate reference data for that evaluation can be re-read and again aggregated on day-of-week, hour-of-day, user, and transaction code and the new reference data used to replace the previously generated reference data. In other examples, the intermediate reference data can be re-read and aggregated using different aggregation parameters (for example, day-of month, minute-of-hour, user, and transaction code).

As will be appreciated by those of ordinary skill in the art, the following example user interfaces are just one possible implementation of user interfaces capable of providing the functionality described in this disclosure. The example figures are not considered to limit the inventive concept and not all aspects, elements, or particular implementations of the provided example figures are considered to be necessary/required to accomplish the described functionalities. In some implementations, various user interfaces, elements of user interfaces, etc. can be combined or separated into fewer or more user interfaces, respectively, to accomplish the described functionality. Unless otherwise specified, other user interfaces consistent with the specification and claims are considered to also be within the scope of this disclosure.

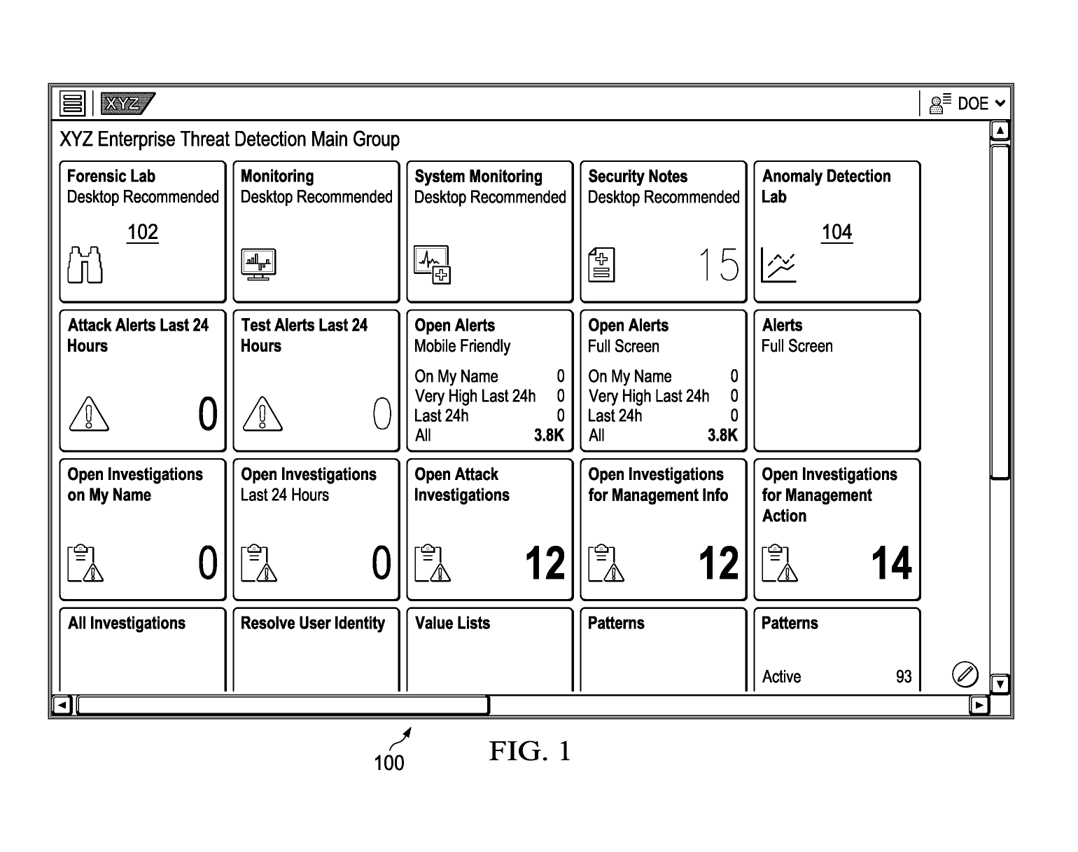

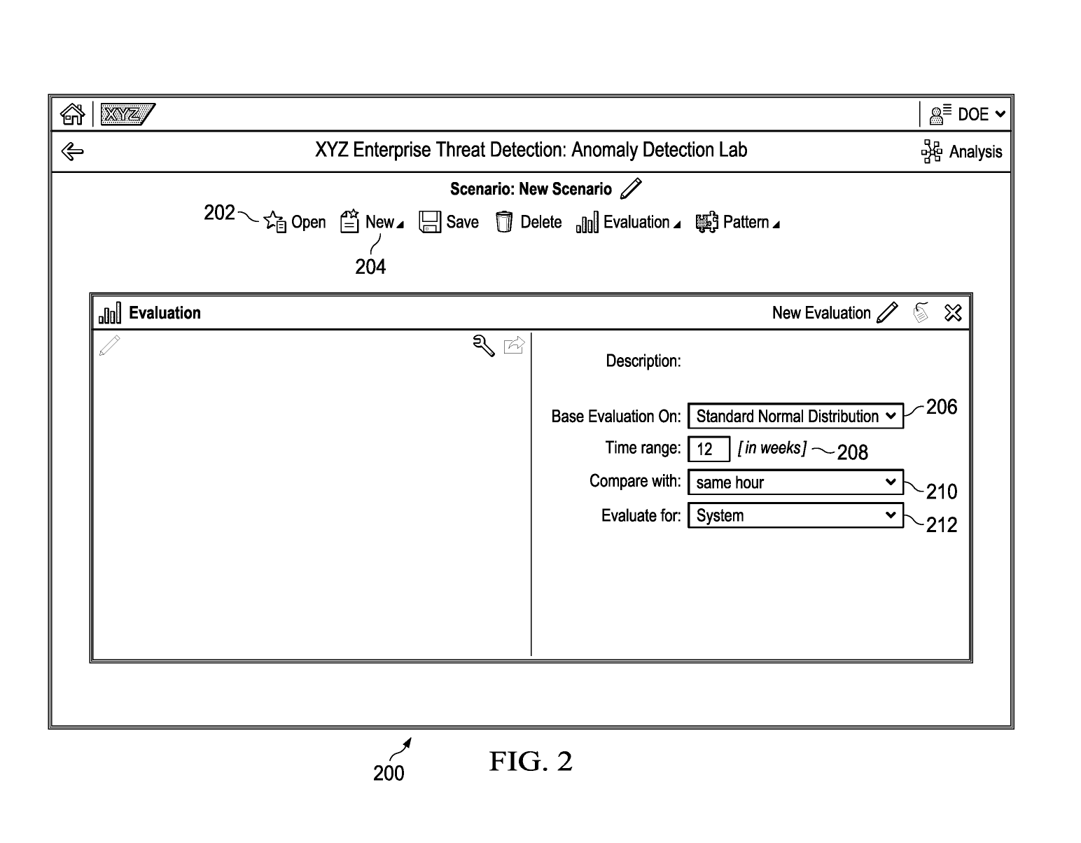

FIG. 1 is a screenshot of an example ETD main group user interface 100, according to an implementation. As illustrated as in typical implementations, the ETD main group user interface 100 comprises a plurality of selectable “tiles” to activate various functions related to ETD. For example, tile 102 is for a “Forensic Lab” and tile 104 is for “Anomaly Detection Lab.” It should be noted that the illustrated tiles are for example only. Other functionalities, as understood by one of ordinary skill in the art and consistent with the specification and claims, are also considered to be within the scope of the disclosure. In this example figure, consider that a user has selected tile 104, “Anomaly Detection Lab” which will open an anomaly detection lab user interface (see, for example, FIG. 2).

Turning now to FIG. 2, FIG. 2 is a screenshot of an example ETD anomaly detection lab user interface 200, according to an implementation. In typical implementations, a user can select to open and review an existing evaluation using interface element 202 or configure a new evaluation using interface element 204. In a typical implementation if selecting element 204, the user is permitted to select a base evaluation value 206 (here “standard normal deviation” is selected), a time range 208 (here “12” in weeks), compared with value 210 (here “same hour”), and evaluate for 212. Field 212 defines what is being identified to evaluate as potentially anomalous (for example, a system, a user, network component, etc.). This information is derived from a chart of selected data types/values (not illustrated) that is assigned/associated with an evaluation. The chart defines what is desired to be observed in available log data. This chart is then added to the left side of FIG. 2 (not illustrated) as an evaluation. As an example, for a chart having “Program Calls of Systems” as content, the attribute in field 212 would be “System” and data types/values associated with program calls of systems is gathered, first as intermediate reference data, and then aggregated into reference data.

For base evaluation value 206, besides the illustrated “Standard Normal Distribution,” other available evaluation methods consistent with this disclosure can also be made available for selection. For time range 208, the time range of the reference data to evaluate is typically measured in weeks with a minimum of four weeks selectable). In other implementations, time can be measured in different units and minimum selectable time ranges can be greater or smaller than the equivalent of four weeks' time.

Value 210 allows a time comparison value. Here, “same hour” indicates that comparisons should be made for the same hour every day for the specified time period (for example, 13:00-14:00 every day). In other implementations, time comparison values can be selectable in different units, multiple time range selections, or other variations consistent with this disclosure.

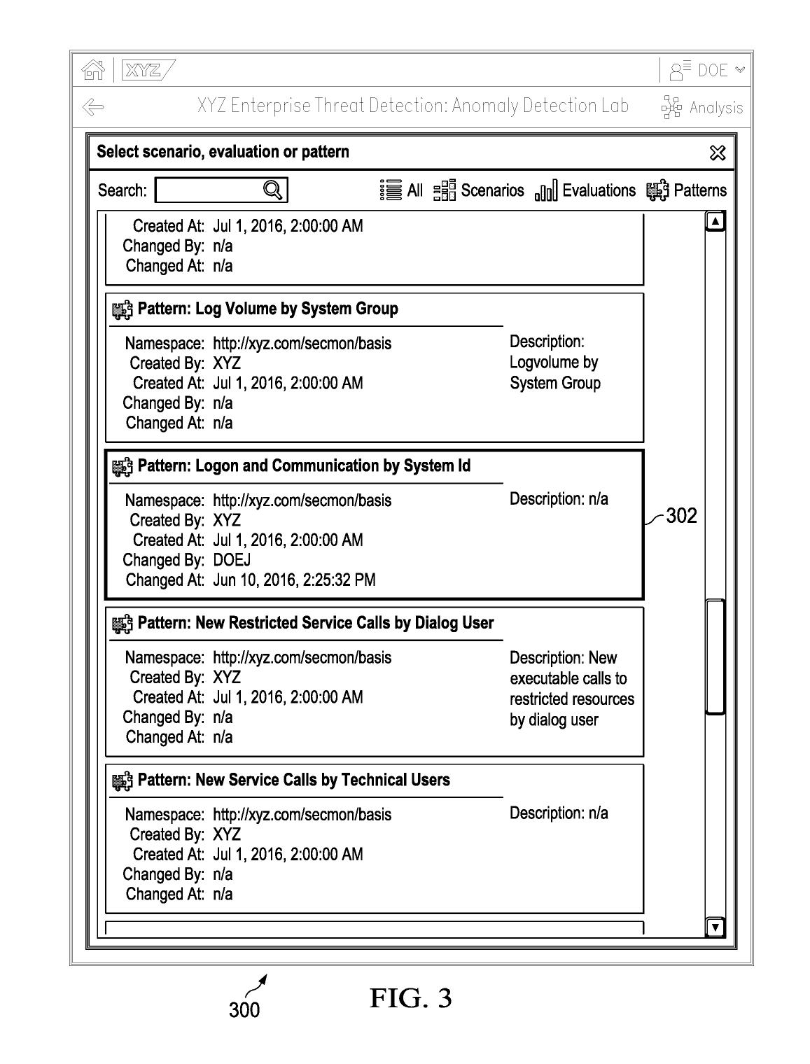

In the alternative, if element 202 is selected, an existing (previously defined) pattern can be selected from a resulting user interface (see, for example, FIG. 3).

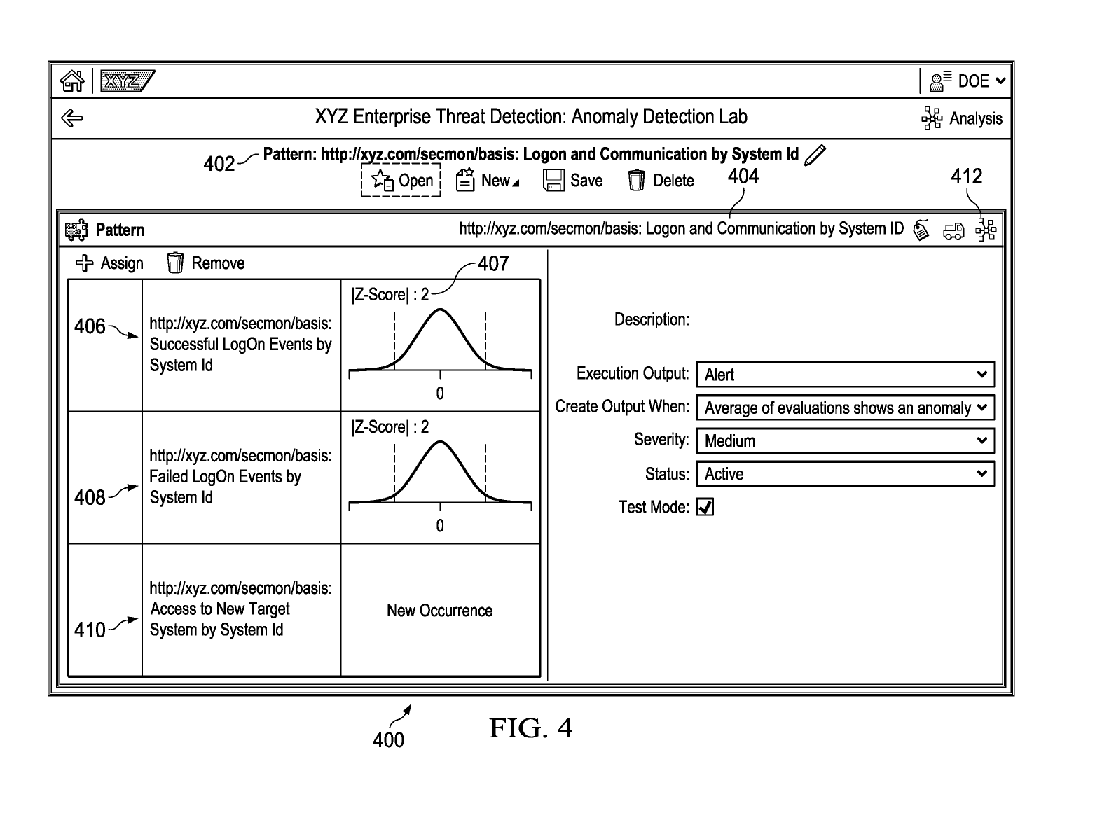

Turning now to FIG. 3, FIG. 3 is a screenshot of an example ETD anomaly detection lab pattern selection user interface 300, according to an implementation. For the purposes of this disclosure, a “pattern” can be considered to be an “evaluation space” as described above. As illustrated, the user chooses to select existing pattern “Logon and Communication by System Id” 302. In this implementation, the user interface element is selectable and also provides information about the pattern (for example, namespace, created by, created at, changed by, changed at, and description values). Once pattern 302 is opened (for example, by double-clicking pattern 302, selecting an “open” or similar user interface element (not illustrated), etc., the pattern is opened for user examination (see, for example, FIG. 4).

Turning now to FIG. 4, FIG. 4 is a screenshot of an example ETD anomaly detection lab pattern definition user interface 400, according to an implementation. Note that this user interface is the same as that in FIG. 2, but now filled in with data corresponding to the pattern 302 selected in FIG. 3. Here, the pattern 302 selected in 302 is identified at 402. Panel 404 identifies and provides descriptive information for the selected pattern 302 (for example, Evaluation Output (here “Alert”), Create Output When (here, “Average of evaluations shows an anomaly”), Severity (here “Medium”), Status (here “Active”), and Test Mode (here checked ON)).

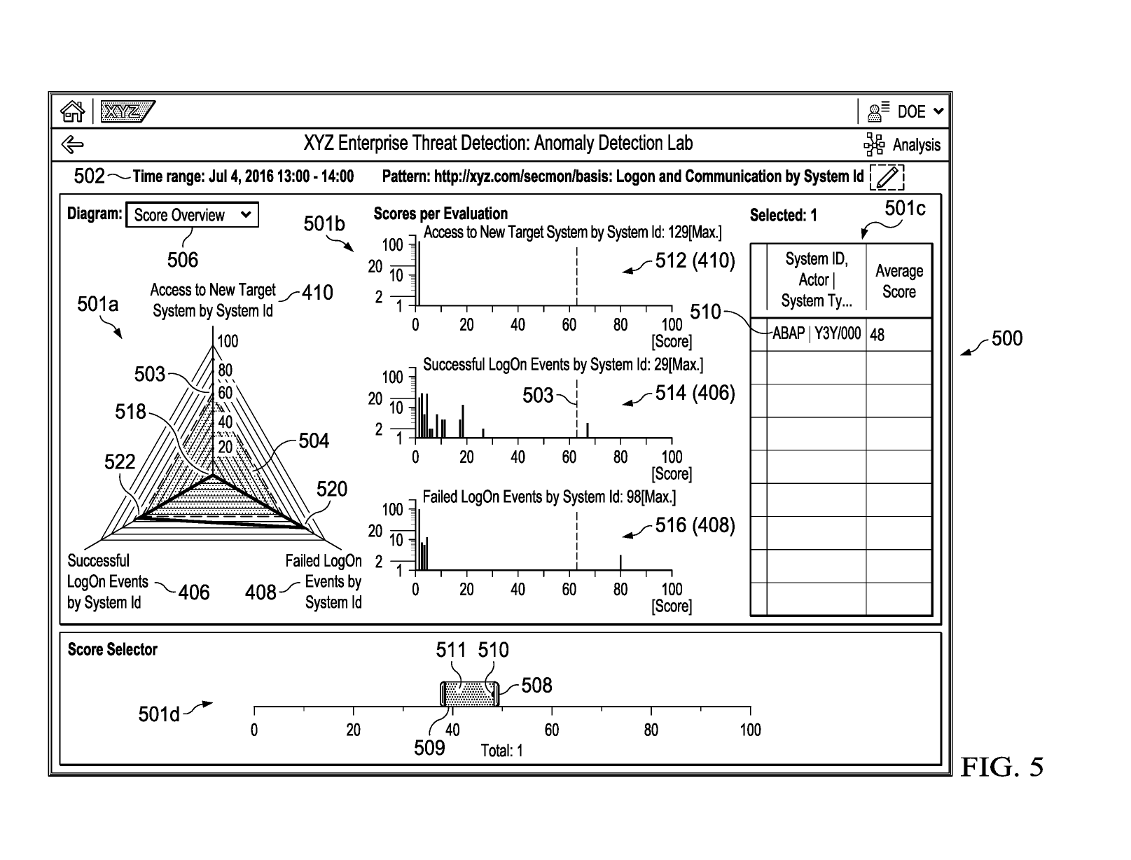

In typical implementations, Evaluation Output (here “Alert”), Create Output When (here, “Average of evaluations shows an anomaly”), Severity (here “Medium”), Status (here “Active”), and Test Mode (here checked ON)) means:
Evaluation Output: Defines what is being created when detecting an anomalous behavior. Either an alert (which needs to be processed or investigated by a monitoring agent) or an indicator only (in this case no processing of monitoring agent is required),
Create Output When: Possible values are “All evaluations show an anomaly”, “At least one evaluation shows an anomaly” or “Average of evaluations shows an anomaly,”
Severity: this defines the severity of an alert (if Alert is selected as Execution Output), and
Test Mode: In case “Alert” is defined as Execution Output, then this option is available. This means that alerts are created as test alerts. No investigation is required by the monitoring agent.
   Particular evaluations associated with pattern 302 to be observed are identified at 406 (“Successful LogOn Events by System Id”), 408 (“Failed LogOn Events by System Id”), and 410 (“Access to New Target System by System Id”). Evaluations use a standard normal distribution statistical calculation with a defined threshold indicating when the value of the standard normal distribution is to be considered unusual (an anomaly/outlier). This threshold value for each evaluation is then normalized in relation to all evaluations to a “score” value (more in FIG. 5).

In this example user interface 400, selecting element 412 will result in an evaluation score diagram for the selected pattern (see, for example, FIG. 5). In typical implementations, a pattern consists of a 1 to n number of evaluations (see FIGS. 4 & 5 for additional detail. Patterns can be designed and defined using, at least in part, the various fields illustrated in FIG. 4. FIG. 5 illustrates a result of the pattern in FIG. 4 containing three evaluations corresponding to the three axes of the evaluation score diagram 501a and the evaluation graphs 501b.

The UI can manage patterns with multiple numbers of evaluations as a customer can create their own patterns having other numbers of evaluations.

Turning now to FIG. 5, FIG. 5 is a screenshot of an example ETD anomaly detection lab analysis user interface 500, according to an implementation. The analysis user interface 500 is divided into an evaluation score diagram 501a, evaluation graphs 501b, entity table 501c, and score selector 501d.

The evaluations 406, 408, and 410 (refer to FIG. 4) are assigned to individual axes in the evaluation score diagram 501a. The standard deviation value for each axis of the designated time range 502 (here “Jul. 4, 2016 13:00-14:00”) is indicated by the limits of the gray portion in the center of the evaluation score diagram 501a (for example, for evaluation 410, the standard deviation has been normalized as a threshold score 503 (here 63)). Note, that while FIG. 5 illustrates the normalized threshold score values for each axis to be the same value (63), the normalized threshold score values can, in some implementations, be different for each axis. In the illustration, lines are drawn between the normalized threshold score values of adjacent axes to generate a standard value zone 504. The zone 504 permits a user to quickly see whether any value plotted on the evaluation score diagram 500 is within or outside of the boundary of the standard value zone 504. If without, the value is considered an outlier and worthy of at least further analysis, determination of criticality, etc. Note that the diagram selector 506 is set to “Score Overview” resulting in the displayed evaluation score diagram 501a. In other implementations, while not illustrated, other visualizations are also possible.

A single entity (510) is identified in FIG. 5 for the selected average score in score selector 501d. Here entity 510 is indicated by a dot near the right side of the score selector ending range vertical bar 508. For example, a selected average evaluation score selection range 509 (in the illustrated implementation, both the right and left sides of the illustrated user interface selector 511 can be moved independently to the right or to the left and illustrate a evaluation score selection range of approximately 37-48) indicates that an entity (here 510) has a mean of selected normalized evaluation scores within that score range. In the selected entity information table 501c, entity 510 is identified as “ABAP|Y3Y/000” with a mean evaluation score (for the three illustrated evaluations (406, 408, and 410) of the selected pattern) of 48. The mean results from the addition of the calculated normalized evaluation scores for the three evaluations divided by three. Note that there can be multiple entities indicated within the selected score selection range 509 which would be displayed in the entity table 501c and reflected in the evaluation score diagram 501a for the selected evaluations in the evaluation graphs 501b.

Evaluation graphs 512, 514, and 516, detail information for evaluations 410, 406, and 408, respectively. Each evaluation graph is shown with a threshold score of 63. Anything above this is score value is considered an outlier. The evaluation graphs 512, 514, and 516 show the distribution of the entities (for example, systems, users, etc.) over their score. Note that for the purposes of this disclosure, evaluation graph 512 will be largely ignored as it is based on a different calculation method that is different from that used in evaluation graphs 514 and 516. For purposes of completeness, at a high level, evaluation 410 means that, for a corresponding system (here Y3Y—the actor system), a set of target systems is defined that the actor system communicates with. Here, in case a new target system (detected by System Id) is communicated with, an anomaly should be indicated (for example, a score of 73) could be assigned if entity 510 communicates with an unknown target system). For this discussion, the normalized score value here can be considered to be 0 as the entity 510 is only communicating with known target systems.

Note that the evaluation graphs 512, 514, and 516, corresponding to evaluations 410, 406, and 408, respectively, are not directly connected to the evaluation score diagram 501a the entity table 501c, or score selector 501d. The evaluation graphs provide the user with a distribution of how many entities (here systems) are acting within and without the acceptable range (here 63). The evaluation graphs indicate data for all entities.

As shown in FIG. 5, entity 510, for evaluations 410 and 406, has a score outside of an acceptable range and is considered anomalous. For example, evaluation graph 514 shows distribution values for evaluation 406 beyond (to the right of) the normalized score of 63 (here approximately 67). Evaluation graph 516 shows distribution values for evaluation 408 with a normalized score of 80. As a further explanation (a similar analysis is applicable to that of evaluation graph 516 for evaluation 408), for evaluation graph 514 (evaluation 406), for the selected time period (here “Jul. 4, 2016 13:00-14:00”) a maximum of 29 different entities (here systems) are indicated as successfully logging on to entity 510 (ABAP Y3Y/000). The analyzed data is received in logs sent from each of the 29 systems (indicating successful logon events). For a reference time range (for this pattern set to a value of four weeks), each occurrence of the successful logon event is saved. Every hour, every day, the number of successful logon events is saved as reference data. From the reference data, a median value can be calculated for the particular event, and then the standard deviation. Values outside the calculated standard deviation are considered anomalous. The further a value is from the standard deviation, the higher the assigned score value.

Continuing the prior example, the value 98 in evaluation graph 516 means that there are approximately 98 systems with normalized score values between 1 and 2. The value 29 in evaluation graph 514 means that there are approximately 29 systems with normalized score values between 2 and 3.

Referring to FIG. 6, FIG. 6 is a screenshot of example ETD anomaly detection lab evaluation detail functionality 600, according to an implementation. For example, evaluation details user interface 702 shows defined values for each evaluation type that are used in the calculation of the standard deviation and normalized score. For evaluation 406 and data considered over the reference period, from 13:00-14:00 on Jul. 4, 2016, there were 221 successful logon events (a combination of all entities—here systems—integrated into the ETD system) detected (reference value 221) connecting to entity 510 (ABAP Y3Y/000). The reference value of 221 is used to calculate the standard deviation value of 108 compared with the reference data. The normalized score of 65 is then calculated. Note that the actual value for this evaluation is 0, but the z-score (see FIG. 4 below) is set to 2. This results in 5 which is not too far from the acceptable range so it results in a score of 65 (for evaluation 408, following a similar analysis, the calculated range is further from the acceptable range, resulting in a score of 80).

As an example, in typical implementations, the score is calculated for every entity (here system) for evaluations 406 and 408 using a score function:

f(X)=(1−ê−[X/threshold]̂2)*100,

where X=[x(actual value)−mean]/standard deviation.

For the following evaluation types:

Evaluation 406—Successful LogOn Events by System Id

Where:
mean=221; standard deviation=108, and
x (actual value for system ABAP/Y3Y/100)=0

Then:

X=(0−221)/108,
threshold=2 (see screenshot showing the pattern and z-score), and

f(x)=(1−ê−[((0−221)/108)/2]̂2)*100=>65.

Evaluation 408—Failed LogOn Events by System Id

Where:
mean=415; standard deviation=165, and
x (actual value for system ABAP/Y3Y/100)=0

Then:

X=(0−415)/165,
threshold=2 (see screenshot showing the pattern and z-score), and

f(x)=(1−ê−[((0−415)/165)/2]̂2)*100=>80.

In general, the more the actual value deviates from the mean and standard deviation, the higher the normalized score of an entity.

Note that the threshold value of 63 is defined as the border between usual and unusual behavior no matter how the threshold (=z-score) is defined (see below). A score of 63 means that:

x(actual value)=mean+z-score*standard deviation.

Referring back to FIG. 4, for evaluation 406, an associated Z-Score factor 407 is indicated with a value of “2.” This means that a value of 2-times the standard deviation is to be considered within the “normal” (acceptable) range (where normalized means a normalized value from 0 to 63). For example, without the factor if the number of saved logon events for this evaluation is much higher than a defined range, it will then receive a normalize score higher than 63 even though fluctuations of the number of successful logon events may be still be considered acceptable. Here the factor helps adjust for this fluctuation and to keep the fluctuations from causing erroneous anomaly indications due to a higher than 63 normalized score.

Returning to FIG. 5, as described above, on the evaluation score diagram 501a, for entity 510 (“ABAP Y3Y/000”) in the specified time range 502, evaluation graph 512 illustrates that evaluation 410 has a normalized evaluation score of 0. This data point (the highest normalized score value) on the axis (at 518) corresponding to evaluation 410 is connected to corresponding data point 520 on the axis for evaluation 408 (here with a highest normalized score of 80). Similarly, the data point on the axis (at 522) corresponding to the highest normalized score of evaluation graph 514 (here 67) is connected back to data point 518 on the axis for evaluation 410 (here 0).

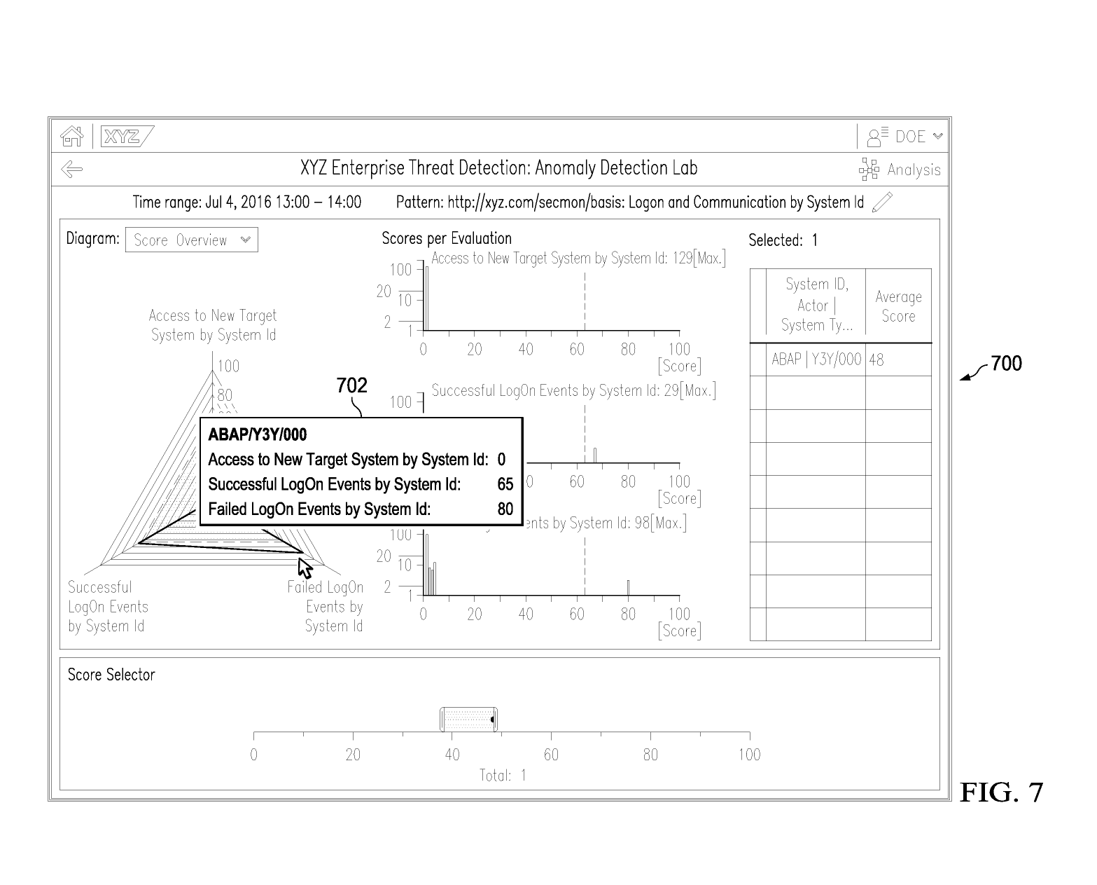

Turning to FIG. 7, FIG. 7 is a screenshot of example ETD anomaly detection lab score tooltip functionality 700, according to an implementation. As illustrated, a user can hover a portion of the evaluation score diagram 501a (for example, an axis) and receive a tooltip 702 that displays the current normalized scores for each corresponding evaluation and the associated entity (here “ABAP/Y3Y/000”).

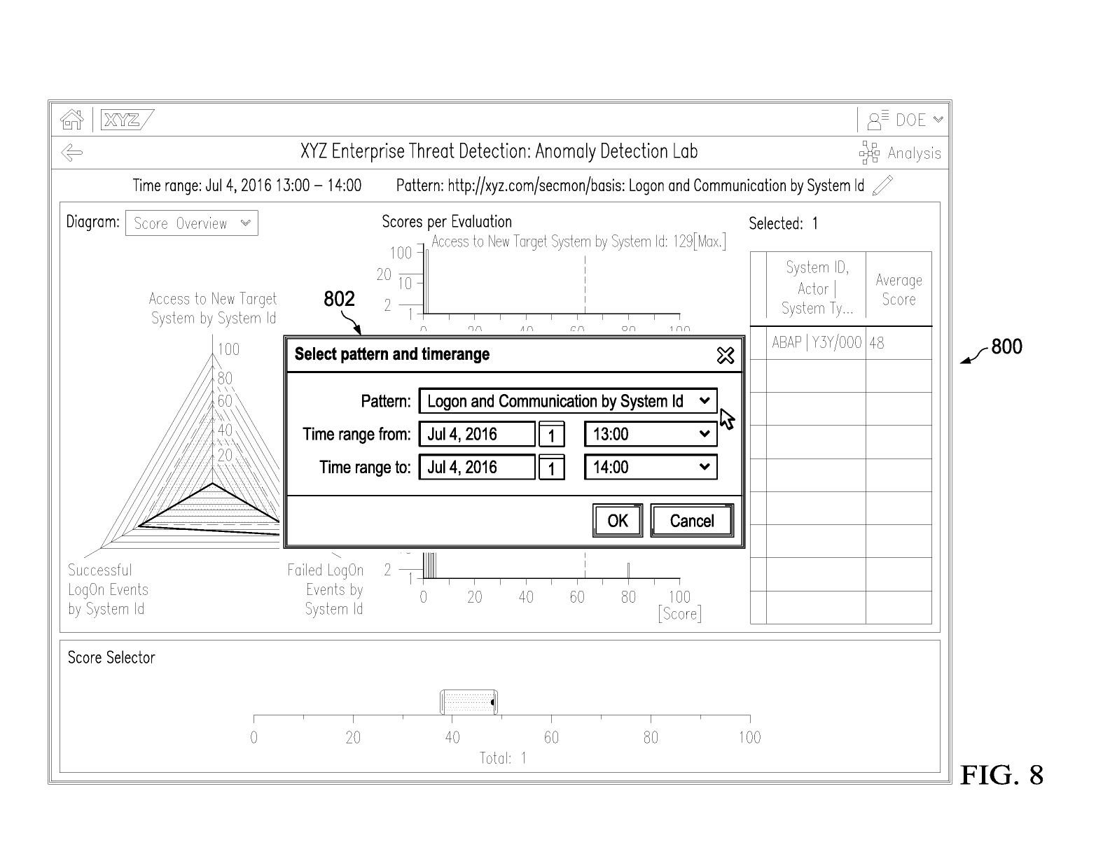

Turning to FIG. 8, FIG. 8 is a screenshot of an example ETD anomaly detection lab pattern selection & time range selection functionality 800, according to an implementation. For example, a user can hover over the evaluation graphs 501b and in a displayed tooltip 802 change the selected pattern or starting time/date and ending time/date for the current evaluations being visualized. As will be appreciated by those of ordinary skill in the art, in other implementations, a different user interface element can be used instead of a tooltip 802 to provide similar functionality.

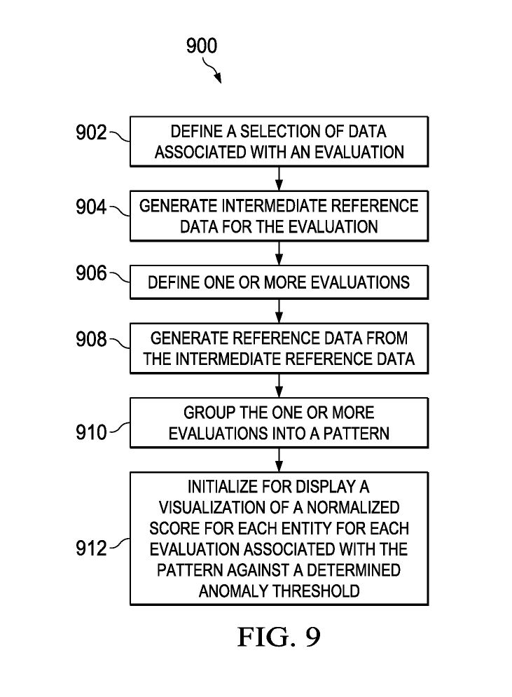

FIG. 9 is a flowchart of an example method 900 for enhanced enterprise threat detection (ETD) using statistical methods, according to an implementation. For clarity of presentation, the description that follows generally describes method 900 in the context of the other figures in this description. However, it will be understood that method 900 may be performed, for example, by any suitable system, environment, software, and hardware, or a combination of systems, environments, software, and hardware as appropriate. In some implementations, various steps of method 900 can be run in parallel, in combination, in loops, or in any order.

At 902, a chart is created, for example in a forensic lab application, to define a selection of data types from available log data for one or more evaluations of log events associated with an entity. The chart defines what is desired to be observed in the log data (for example, “Program Calls of Systems” as content). From 902, method 900 proceeds to 904.

At 904, intermediate reference data is generated for the selected data types associated with the one or more evaluations. From 904, method 900 proceeds to 906.

At 906, one or more evaluations associated with the entity are defined. Each evaluation defines, for example, time-based information and an evaluation method. From 906, method 900 proceeds to 908.

At 908, reference data is generated from the intermediate reference data based on each defined evaluation. The generation of reference data includes aggregating the intermediate reference data based on a particularly defined aggregation level for the evaluation determined by entity-based characteristics and on time-based information. Once a defined evaluation is activated, reference data is built up on regular basis (for example, through a scheduled job). From 908, method 900 proceeds to 910.

At 910, the one or more evaluations are grouped into a pattern. From 910, method 900 proceeds to 912.

At 912, initialize a visualization for display in a graphical user interface of a normalized score for each entity for each evaluation associated with the pattern against a determined anomaly threshold. For example, a security analyst can start a manual analysis to compare a selected time frame of reference data in a visualization (for example, FIG. 5 in an evaluation score diagram). Based on any alerts/indicators created by anomaly pattern execution, follow up analysis can take place in an anomaly detection lab or a forensic lab. From 912, method 900 stops.

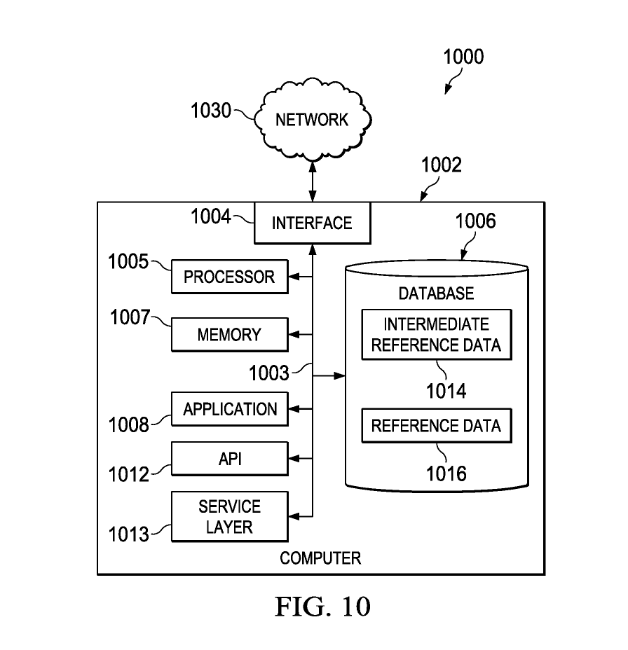

FIG. 10 is a block diagram of an exemplary computer system 1000 used to provide computational functionalities associated with described algorithms, methods, functions, processes, flows, and procedures as described in the instant disclosure, according to an implementation. The illustrated computer 1002 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 1002 may comprise a computer that includes an input device, such as a keypad, keyboard, touch screen, or other device that can accept user information, and an output device that conveys information associated with the operation of the computer 1002, including digital data, visual, or audio information (or a combination of information), or a GUI.

The computer 1002 can serve in a role as a client, network component, a server, a database or other persistency, or any other component (or a combination of roles) of a computer system for performing the subject matter described in the instant disclosure. The illustrated computer 1002 is communicably coupled with a network 1030. In some implementations, one or more components of the computer 1002 may be configured to operate within environments, including cloud-computing-based, local, global, or other environment (or a combination of environments).

At a high level, the computer 1002 is an electronic computing device operable to receive, transmit, process, store, or manage data and information associated with the described subject matter. According to some implementations, the computer 1002 may also include or be communicably coupled with an application server, e-mail server, web server, caching server, streaming data server, business intelligence (BI) server, or other server (or a combination of servers).

The computer 1002 can receive requests over network 1030 from a client application (for example, executing on another computer 1002) and responding to the received requests by processing the said requests in an appropriate software application. In addition, requests may also be sent to the computer 1002 from internal users (for example, from a command console or by other appropriate access method), external or third-parties, other automated applications, as well as any other appropriate entities, individuals, systems, or computers.

Each of the components of the computer 1002 can communicate using a system bus 1003. In some implementations, any or all of the components of the computer 1002, both hardware or software (or a combination of hardware and software), may interface with each other or the interface 1004 (or a combination of both) over the system bus 1003 using an application programming interface (API) 1012 or a service layer 1013 (or a combination of the API 1012 and service layer 1013). The API 1012 may include specifications for routines, data structures, and object classes. The API 1012 may be either computer-language independent or dependent and refer to a complete interface, a single function, or even a set of APIs. The service layer 1013 provides software services to the computer 1002 or other components (whether or not illustrated) that are communicably coupled to the computer 1002. The functionality of the computer 1002 may be accessible for all service consumers using this service layer. Software services, such as those provided by the service layer 1013, provide reusable, defined business functionalities through a defined interface. For example, the interface may be software written in JAVA, C++, or other suitable language providing data in extensible markup language (XML) format or other suitable format. While illustrated as an integrated component of the computer 1002, alternative implementations may illustrate the API 1012 or the service layer 1013 as stand-alone components in relation to other components of the computer 1002 or other components (whether or not illustrated) that are communicably coupled to the computer 1002. Moreover, any or all parts of the API 1012 or the service layer 1013 may be implemented as child or sub-modules of another software module, enterprise application, or hardware module without departing from the scope of this disclosure.

The computer 1002 includes an interface 1004. Although illustrated as a single interface 1004 in FIG. 10, two or more interfaces 1004 may be used according to particular needs, desires, or particular implementations of the computer 1002. The interface 1004 is used by the computer 1002 for communicating with other systems in a distributed environment that are connected to the network 1030 (whether illustrated or not). Generally, the interface 1004 comprises logic encoded in software or hardware (or a combination of software and hardware) and operable to communicate with the network 1030. More specifically, the interface 1004 may comprise software supporting one or more communication protocols associated with communications such that the network 1030 or interface's hardware is operable to communicate physical signals within and outside of the illustrated computer 1002.

The computer 1002 includes a processor 1005. Although illustrated as a single processor 1005 in FIG. 10, two or more processors may be used according to particular needs, desires, or particular implementations of the computer 1002. Generally, the processor 1005 executes instructions and manipulates data to perform the operations of the computer 1002 and any algorithms, methods, functions, processes, flows, and procedures as described in the instant disclosure.

The computer 1002 also includes a database 1006 that can hold data for the computer 1002 or other components (or a combination of both) that can be connected to the network 1030 (whether illustrated or not). For example, database 1006 can be an in-memory, conventional, or other type of database storing data consistent with this disclosure. In some implementations, database 1006 can be a combination of two or more different database types (for example, a hybrid in-memory and conventional database) according to particular needs, desires, or particular implementations of the computer 1002 and the described functionality. Although illustrated as a single database 1006 in FIG. 10, two or more databases (of the same or combination of types) can be used according to particular needs, desires, or particular implementations of the computer 1002 and the described functionality. While database 1006 is illustrated as an integral component of the computer 1002, in alternative implementations, database 1006 can be external to the computer 1002. As illustrated, the database 1006 holds both intermediate reference data 1014 and reference data 1016 as described above.

The computer 1002 also includes a memory 1007 that can hold data for the computer 1002 or other components (or a combination of both) that can be connected to the network 1030 (whether illustrated or not). For example, memory 1007 can be random access memory (RAM), read-only memory (ROM), optical, magnetic, and the like storing data consistent with this disclosure. In some implementations, memory 1007 can be a combination of two or more different types of memory (for example, a combination of RAM and magnetic storage) according to particular needs, desires, or particular implementations of the computer 1002 and the described functionality. Although illustrated as a single memory 1007 in FIG. 10, two or more memories 1007 (of the same or combination of types) can be used according to particular needs, desires, or particular implementations of the computer 1002 and the described functionality. While memory 1007 is illustrated as an integral component of the computer 1002, in alternative implementations, memory 1007 can be external to the computer 1002.

The application 1008 is an algorithmic software engine providing functionality according to particular needs, desires, or particular implementations of the computer 1002, particularly with respect to functionality described in this disclosure. For example, application 1008 can serve as one or more components, modules, applications, etc. Further, although illustrated as a single application 1008, the application 1008 may be implemented as multiple applications 1007 on the computer 1002. In addition, although illustrated as integral to the computer 1002, in alternative implementations, the application 1008 can be external to the computer 1002.

There may be any number of computers 1002 associated with, or external to, a computer system containing computer 1002, each computer 1002 communicating over network 1030. Further, the term “client,” “user,” and other appropriate terminology may be used interchangeably as appropriate without departing from the scope of this disclosure. Moreover, this disclosure contemplates that many users may use one computer 1002, or that one user may use multiple computers 1002.

Described implementations of the subject matter can include one or more features, alone or in combination.

For example, in a first implementation, a computer-implemented method, comprising: defining a selection of data types from available log data for an evaluation of events associated with an entity; defining one or more evaluations associated with the entity; generating reference data from the selection of data types based on the one or more defined evaluations; grouping the one or more evaluations into a pattern; and initializing for display in a graphical user interface a visualization of a normalized score for the entity for each evaluation associated with the pattern against a determined anomaly threshold.

The foregoing and other described implementations can each optionally include one or more of the following features:

A first feature, combinable with any of the following features, wherein an entity is a member of a group consisting of a user and a computer system.

A second feature, combinable with any of the previous or following features, comprising generating intermediate reference data according to the selected data types, wherein the intermediate reference data is stored in a database.

A third feature, combinable with any of the previous or following features, wherein the generation of reference data is based on the one or more defined evaluations.

A fourth feature, combinable with any of the previous or following features, wherein the generation of reference data comprises aggregating the intermediate reference data based on a particularly defined aggregation level for the evaluation determined by entity-based characteristics and on time-based information.

A fifth feature, combinable with any of the previous or following features, wherein the one or more evaluations grouped into the pattern are analyzed based on pattern-level settings.

A sixth feature, combinable with any of the previous or following features, wherein the normalized score is calculated using:

f(X)=(1−ê−[X/threshold]̂2)*100,

where X=[x(actual value)−mean]/standard deviation.

In a second implementation, a non-transitory, computer-readable medium storing one or more instructions executable by a computer system to perform operations comprising: defining a selection of data types from available log data for an evaluation of events associated with an entity; defining one or more evaluations associated with the entity; generating reference data from the selection of data types based on the one or more defined evaluations; grouping the one or more evaluations into a pattern; and initializing for display in a graphical user interface a visualization of a normalized score for the entity for each evaluation associated with the pattern against a determined anomaly threshold.

The foregoing and other described implementations can each optionally include one or more of the following features:

A first feature, combinable with any of the following features, wherein an entity is a member of a group consisting of a user and a computer system.

A second feature, combinable with any of the previous or following features, comprising one or more instructions to generate intermediate reference data according to the selected data types, wherein the intermediate reference data is stored in a database.

A third feature, combinable with any of the previous or following features, wherein the generation of reference data is based on the one or more defined evaluations.

A fourth feature, combinable with any of the previous or following features, wherein the generation of reference data comprises one or more instructions to aggregate the intermediate reference data based on a particularly defined aggregation level for the evaluation determined by entity-based characteristics and on time-based information.

A fifth feature, combinable with any of the previous or following features, wherein the one or more evaluations grouped into the pattern are analyzed based on pattern-level settings.

A sixth feature, combinable with any of the previous or following features, wherein the normalized score is calculated using:

f(X)=(1−ê−[X/threshold]̂2)*100,

where X=[x(actual value)−mean]/standard deviation.

In a third implementation, a computer-implemented system, comprising: a computer memory; and a hardware processor interoperably coupled with the computer memory and configured to perform operations comprising: defining a selection of data types from available log data for an evaluation of events associated with an entity; defining one or more evaluations associated with the entity; generating reference data from the selection of data types based on the one or more defined evaluations; grouping the one or more evaluations into a pattern; and initializing for display in a graphical user interface a visualization of a normalized score for the entity for each evaluation associated with the pattern against a determined anomaly threshold.

The foregoing and other described implementations can each optionally include one or more of the following features:

A first feature, combinable with any of the following features, wherein an entity is a member of a group consisting of a user and a computer system.

A second feature, combinable with any of the previous or following features, configured to generate intermediate reference data according to the selected data types, wherein the intermediate reference data is stored in a database.

A third feature, combinable with any of the previous or following features, wherein the generation of reference data is based on the one or more defined evaluations.

A fourth feature, combinable with any of the previous or following features, wherein the generation of reference data comprises one or more configurations to aggregate the intermediate reference data based on a particularly defined aggregation level for the evaluation determined by entity-based characteristics and on time-based information.

A fifth feature, combinable with any of the previous or following features, wherein the one or more evaluations grouped into the pattern are analyzed based on pattern-level settings.

A sixth feature, combinable with any of the previous or following features, wherein the normalized score is calculated using:

f(X)=(1−ê−[X/threshold]̂2)*100,

where X=[x(actual value)−mean]/standard deviation.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM), or both. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and CD-ROM, DVD+/-R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware or software (or a combination of hardware and software), may interface with each other or the interface using an application programming interface (API) or a service layer (or a combination of API and service layer). The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API or service layer (or a combination of the API and the service layer) may be an integral or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described above should not be understood as requiring such separation or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

Furthermore, any claimed implementation below is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
defining a selection of data types from available log data for an evaluation of events associated with an entity;
defining one or more evaluations associated with the entity;
generating reference data from the selection of data types based on the one or more defined evaluations;
grouping the one or more evaluations into a pattern; and
initializing for display in a graphical user interface a visualization of a normalized score for the entity for each evaluation associated with the pattern against a determined anomaly threshold.

2. The computer-implemented method of claim 1, wherein an entity is a member of a group consisting of a user and a computer system.

3. The computer-implemented method of claim 1, comprising generating intermediate reference data according to the selected data types, wherein the intermediate reference data is stored in a database.

4. The computer-implemented method of claim 3, wherein the generation of reference data is based on the one or more defined evaluations.

5. The computer-implemented method of claim 4, wherein the generation of reference data comprises aggregating the intermediate reference data based on a particularly defined aggregation level for the evaluation determined by entity-based characteristics and on time-based information.

6. The computer-implemented method of claim 1, wherein the one or more evaluations grouped into the pattern are analyzed based on pattern-level settings.

7. The computer implemented method of claim 1, wherein the normalized score is calculated using:
f(X)=(1−ê−[X/threshold]̂2)*100,
where X=[x(actual value)−mean]/standard deviation.

8. A non-transitory, computer-readable medium storing one or more instructions executable by a computer system to perform operations comprising:
defining a selection of data types from available log data for an evaluation of events associated with an entity;
defining one or more evaluations associated with the entity;
generating reference data from the selection of data types based on the one or more defined evaluations;
grouping the one or more evaluations into a pattern; and
initializing for display in a graphical user interface a visualization of a normalized score for the entity for each evaluation associated with the pattern against a determined anomaly threshold.

9. The non-transitory, computer-readable medium of claim 8, wherein an entity is a member of a group consisting of a user and a computer system.

10. The non-transitory, computer-readable medium of claim 8, comprising one or more instructions to generate intermediate reference data according to the selected data types, wherein the intermediate reference data is stored in a database.

11. The non-transitory, computer-readable medium of claim 10, wherein the generation of reference data is based on the one or more defined evaluations.

12. The non-transitory, computer-readable medium of claim 11, wherein the generation of reference data comprises one or more instructions to aggregate the intermediate reference data based on a particularly defined aggregation level for the evaluation determined by entity-based characteristics and on time-based information.

13. The non-transitory, computer-readable medium of claim 8, wherein the one or more evaluations grouped into the pattern are analyzed based on pattern-level settings.

14. The non-transitory, computer-readable medium of claim 8, wherein the normalized score is calculated using:
f(X)=(1−ê−[X/threshold]̂2)*100,
where X=[x(actual value)−mean]/standard deviation.

15. A computer-implemented system, comprising:
a computer memory; and
a hardware processor interoperably coupled with the computer memory and configured to perform operations comprising:
defining a selection of data types from available log data for an evaluation of events associated with an entity;
defining one or more evaluations associated with the entity;
generating reference data from the selection of data types based on the one or more defined evaluations;
grouping the one or more evaluations into a pattern; and
initializing for display in a graphical user interface a visualization of a normalized score for the entity for each evaluation associated with the pattern against a determined anomaly threshold.

16. The computer-implemented system of claim 15, wherein an entity is a member of a group consisting of a user and a computer system.

17. The computer-implemented system of claim 15, configured to generate intermediate reference data according to the selected data types, wherein the intermediate reference data is stored in a database.

18. The computer-implemented system of claim 17, wherein the generation of reference data is based on the one or more defined evaluations.

19. The computer-implemented system of claim 18, wherein the generation of reference data comprises one or more configurations to aggregate the intermediate reference data based on a particularly defined aggregation level for the evaluation determined by entity-based characteristics and on time-based information.

20. The computer-implemented system of claim 15, wherein the normalized score is calculated using:
f(X)=(1−ê−[X/threshold]̂2)*100,
where X=[x(actual value)−mean]/standard deviation.
